(19) United States
(12) Patent Application Publication
(10) Pub. No.: US 2012/0067057 A1
(43) Pub. Date: Mar. 22, 2012

(54) Intake air temperature control device and a method for operating an intake air temperature control device

(76) Inventors: Daniel Hofmann, Uttenreuth (DE); Erich Schmid, Marloffstein (DE); Michael Schöttler, Erlangen (DE)

(21) Appl. No.: 13/322,158

(22) PCT Filed: May 25, 2010
(86) PCT No.: PCT/EP2010/057161

§ 371 Date: Nov. 23, 2011

(30) Foreign Application Priority Data
May 28, 2009 (EP) 09161355.4

(51) Int. Cl. F02C 3/30

(52) U.S. Cl. 60/775; 60/39.19

(57) ABSTRACT

An intake air temperature control device including a heat exchanger is provided. The heat exchanger is connected at one side into an intake air line and is connected at the other side into a circuit of an intake air preheating system, wherein a store for a fluid for heat transfer may be thermally connected to the circuit. A method for operating an intake air temperature control device is also provided.

### CROSS REFERENCE TO RELATED APPLICATIONS

This application is the US National Stage of International Application No. PCT/EP2010/057161, filed May 25, 2010 and claims the benefit thereof. The International Application claims the benefits of German application No. 09161355.4 EP filed May 28, 2009. All of the applications are incorporated by reference herein in their entirety.

### FIELD OF INVENTION

The invention relates to an intake air temperature control device, in particular for a gas and steam turbine plant, and to a method for operating such a device, and concerns in particular an improvement in peak load operation of a gas and steam turbine plant.

### BACKGROUND OF INVENTION

It is known that the performance of gas and steam turbine plants is dependent inter alia on the intake air temperature of the gas turbine and that a lower power output is generated at high ambient temperature. In hot countries there are peaks in electricity consumption according to the time of day, said peaks being caused, among other factors, by the increased electricity demand for cooling equipment. In electricity markets based on pricing according to supply and demand this high level of consumption leads to high electricity prices, particularly in the afternoon. Although a higher power output of the gas and steam turbine plant would be possible during the night, both the demand for and the price of electricity are usually low.

In order to deal with this problem it is possible at times of peak load for example to cool the intake air by means of evaporative cooling upstream of the gas turbine. However, the effectiveness of this method depends on the air humidity and leads only to a limited increase in performance. The water requirements and/or water losses associated herewith are also disadvantageous.

Alternatively the power output losses due to high ambient temperatures at the gas turbine can be compensated by means of an additional firing of a heat recovery steam generator. The disadvantages of this solution lie in the additional manufacturing costs, the reduction in efficiency and the overdimensioning of the water-steam circuit, the steam turbine and, if no single-shaft system is present, the steam turbine generator.

In principle losses in power output can of course be compensated for through the use of reserve power. However, additional gas and steam turbine plants and equipment lead to high costs while providing a comparatively short service life.

Finally the intake air of the gas turbine can be cooled by means of conventional cooling machines or chillers. However, the chillers themselves consume a great deal of electricity. The method leads to no significant increase in performance.

### SUMMARY OF INVENTION

The object of the invention is to improve the peak load operation of a gas turbine plant, in particular a gas and steam turbine plant, in such a way that high power output is achieved at the same time as a high level of efficiency.

This object is achieved according to the invention by means of the device as claimed in the claims and the method as claimed in the claims. Advantageous developments of the invention are defined in the respective dependent claims.

In an intake air temperature control device comprising a heat exchanger connected at one side into an intake air line and at the other side into a circuit of an intake air preheating system, the following is achieved by means of a reservoir for a heat transfer fluid which can be thermally coupled to the circuit:

In contemporary and future gas and steam turbine plants the intake air preheater system (APH) is already present in many installations on account of the partial load reduction at night and at weekends (CO problem). By way of the reservoir a fluid is now made available by means of which the temperature of the intake air can be influenced with the aid of the already existing intake air preheater system. In this case the intake air preheater system can also be used for cooling the air in the same way as for preheating the air.

Advantageously, the reservoir can be thermally coupled to the circuit by means of a first fluid line that branches off from the reservoir and leads into the circuit and a second fluid line that branches off from the circuit and leads into the reservoir. In this arrangement the fluid is pumped directly into the intake air preheating system and can influence the temperature of the intake air for a gas turbine by way of the heat exchanger of the intake air preheating system.

Alternatively, a heat exchanger is inserted into the circuit and connected to the reservoir by way of a first and a second fluid line. In this case the fluid forms a separate circuit with reservoir and heat exchanger and the circuit of the intake air preheating system remains unchanged.

The fluid heated by the heat exchange with the intake air can beneficially be cooled down again by connecting an air-fluid heat exchanger at one side into a reservoir circuit and at the other side into an air line branching off from a compressor, the reservoir circuit comprising the reservoir, a third fluid line connected between the first and the second fluid line, as well as sections of the first and the second fluid line from the reservoir up to the third fluid line.

For this purpose at least one further heat exchanger for cooling the air is advantageously connected into the air line branching off from the compressor in the flow direction of the air on the primary side upstream of the air-fluid heat exchanger. The further heat exchanger can be connected for example into the water-steam circuit of a gas and steam turbine plant and used for heating up feedwater.

In order to cool down the compressor air further still a pressure reducing valve is advantageously connected into the air line between the further heat exchanger and the air-fluid heat exchanger.

Alternatively, an air expansion turbine can advantageously be connected into the air line between the further heat exchanger and the air-fluid heat exchanger.

In an advantageous embodiment variant of the invention the heat transfer fluid is a mixture composed of water and antifreezing agent (e.g. glycol or ethanol). A mixture of water and antifreezing agent is particularly suitable for such an application by virtue of a high heat transfer coefficient and the lowering of the freezing point of the water caused by the antifreezing agent.

The intake air temperature control device is advantageously part of a gas turbine plant or a gas and steam turbine plant.

In the inventive method for operating an intake air temperature control device comprising an intake air preheating system, a fluid intended for transferring heat is drawn off from a reservoir and supplied to the intake air preheating system for the purpose of adjusting the temperature of intake air.

Compressor air which itself must first be cooled down is advantageously used for regenerating the fluid. It is advantageous in this case if compressed compressor air is cooled down in the heat exchange with water, for example medium- or low-pressure feedwater of a water-steam circuit of a gas and steam turbine plant.

It is additionally advantageous if a throttle expands the cooled compressor air in order to achieve further cooling.

Alternatively it may also be beneficial to expand the compressor air in an expansion turbine.

In order to realize the inventive device or inventive method, only minor modifications to a gas and steam turbine plant having an intake air preheating system that is present anyway are necessary in the form of an additional heat exchanger, depending on whether the heat transfer fluid is incorporated directly into the intake air preheating system or by way of a heat exchanger.

Furthermore, the demand for electricity and also the electricity revenues are generally lowest during the night. In order to utilize the capacity of the gas and steam turbine plant, some of the energy generated can now be converted for example into cold fluid and stored, this being used to provide additional power output during the day at a time of high electricity revenues. The gas and steam turbine plant thus becomes similar to a reservoir power station which consumes power when electricity prices are low and at times of high electricity revenues is able to generate additional power without changing its nominal capacity. Depending on the design of the systems the cooling of the intake air e.g. from approx. +40° C. to +10° C. effects an increase in performance by 15-20%.

The technical overhead in terms of equipment is less than in the case of a solution using conventional chillers and the efficiency of the system (in particular with expansion turbine) is also significantly higher. As well as handling the previous functions (CO avoidance under partial load, light load) the intake air preheating system that is necessary in most installations anyway is utilized in addition for cooling at times of high outside temperatures and can therefore be used considerably more cost-effectively.

In wintertime or generally when ambient temperatures are low the device can also substantially reduce the requirement for auxiliary steam for the so-called anti-icing operation of the gas turbine by storing hot water, the reservoir likewise being discharged by way of the intake air preheating system. A combination of low outside temperatures and high relative air humidity values namely results in a greatly increased risk of icing for the intake system and the entire gas turbine. The risks include the icing of the filters and the reduction or blocking of the air supply resulting therefrom. The former leads to reduced power output, the latter means shutdown of the plant. Far more problematic, however, are ice crystals or drops which penetrate the turbine and come into contact with the turbine blades. In the best case this means increased wear and tear, in the worst case premature destruction of the plant. It is therefore technically and economically of paramount importance to prevent icing effectively. Adding antifreezing agent prevents the water from freezing in the course of heat exchange with cold intake air. The heat required for heating up the mixture of water and antifreezing agent is taken for example from the steam systems of the water-steam circuit of a gas and steam turbine plant.

In addition to being used in anti-icing operation, the stored hot water can also help substantially increase the efficiency of the plant in partial load operation.

Buildings and units of space can also be easily heated and cooled with the aid of the cold and/or hot water reservoir. Depending on the design and mode of operation of the reservoir it is also possible for cooling and heating to be performed in parallel if necessary.

### BRIEF DESCRIPTION OF THE DRAWINGS

The invention is explained in an exemplary manner in more detail with reference to the schematic and not-to-scale drawings, in which:

FIG. 1 shows a gas turbine plant and a contemporary gas turbine intake air preheating system,

FIG. 2 shows an intake air temperature control device having direct thermal coupling through injection of the fluid from the reservoir into the intake air preheating system,

FIG. 3 shows an intake air temperature control device having indirect thermal coupling by way of a heat exchanger,

FIG. 4 shows the generation of cold fluid with throttle valve in the compressor air line,

FIG. 5 shows the generation of cold fluid with expansion turbine in the compressor air line,

FIG. 6 shows the integration of the generation of cold fluid into the water-steam circuit of a gas and steam turbine plant, and

FIG. 7 shows the reservoir of the intake air temperature control device being used as a heat accumulator.

### DETAILED DESCRIPTION OF INVENTION

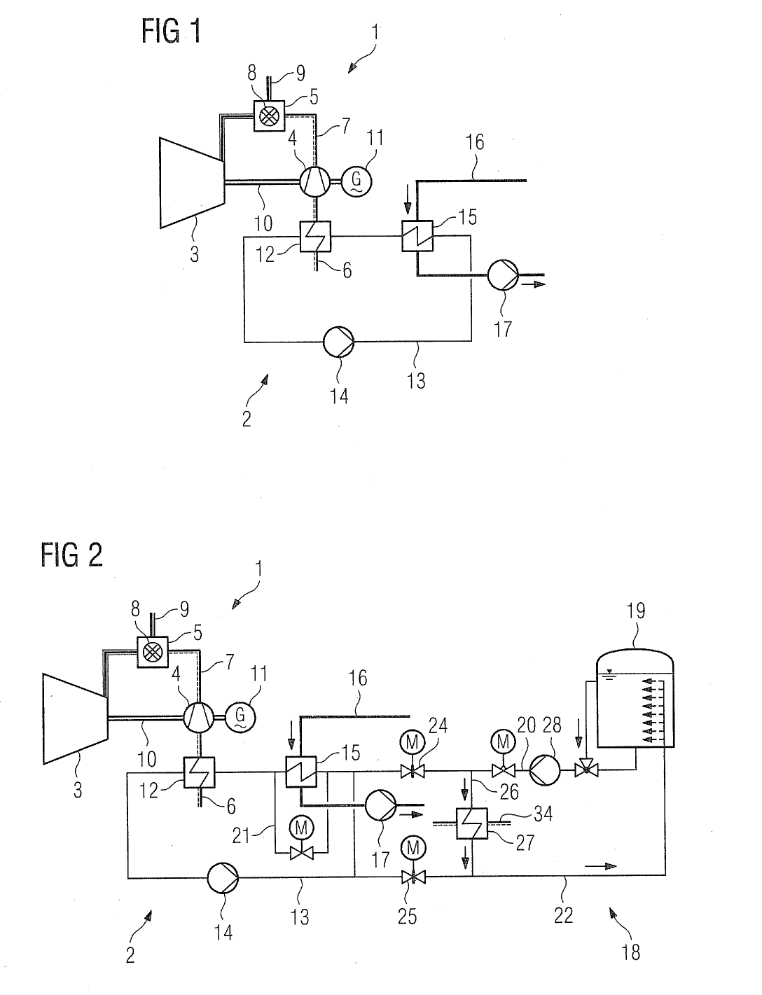

Shown schematically and by way of example in FIG. 1 is a gas turbine plant 1 and a contemporary gas turbine intake air preheating system 2 of a gas and steam turbine plant. The gas turbine plant 1 is equipped with a gas turbine 3, a compressor 4 and at least one combustion chamber 5 connected between the compressor 4 and the gas turbine 3. Fresh air is drawn in by means of the compressor 4 by way of the intake air line 6, compressed and supplied to one or more burners 8 of the combustion chamber 5 by way of the fresh air line 7. The supplied air is mixed with liquid or gaseous fuel supplied by way of a fuel line 9 and the mixture ignited. The resulting combustion exhaust gases form the working medium of the gas turbine plant 1, which working medium is supplied to the gas turbine 3, where it performs work through expansion and drives a shaft 10 coupled to the gas turbine 3. In addition to being connected to the gas turbine 3 the shaft 10 is also coupled to the air compressor 4 as well as to a generator 11 in order to drive the latter components.

The preheating of the intake air leads to a reduction in the total mass flow of fuel-air mixture which can be supplied overall per time unit to the gas turbine 3, so that the maximum power output attainable by the gas turbine plant 1 is lower than if the preheating of the intake air were dispensed with. That said, however, the heat supplied during the preheating of the intake air causes the fuel consumption to drop more sharply than the maximum attainable power output, with the result that the overall level of efficiency increases.

The intake air preheating system 2 consists of a heat exchanger 12 connected at one side into the intake air line 6 and at the other side into a circuit 13 of the intake air preheating system 2 in which a fluid is circulated by a circulating pump 14. A further heat exchanger 15 connected into the circuit 13 on the secondary side is connected into a water-steam circuit 16 with pump 17 on the primary side. Steam flowing through the further heat exchanger 15 heats the circulating fluid and condenses in the process. The resulting condensate is discharged by way of the pump 17. The heated fluid in turn transfers the absorbed heat in the heat exchanger 12 to the intake air in the intake air line 6.

FIG. 2 shows an intake air temperature control device 18 according to a first embodiment variant of the invention with direct injection of a cold fluid into the intake air preheating system 2. The fluid can be for example water, an antifreezing agent or a mixture of water and antifreezing agent. In this case the cold fluid is injected directly into the intake air preheating system 2 from a reservoir 19 by way of a first fluid line 20. The cold fluid flows through a bypass 21 past the heat exchanger 15, which normally heats up the fluid of the intake air preheating system 2, and reaches the heat exchanger 12 which is connected into the intake air line 6. There the cold fluid absorbs heat from the intake air, cooling down the latter in the process, and is then pumped back into the reservoir 19 again by way of a second fluid line 22. If necessary the reservoir 19 can be decoupled from the intake air preheating system 2 by means of the valves 24 and 25.

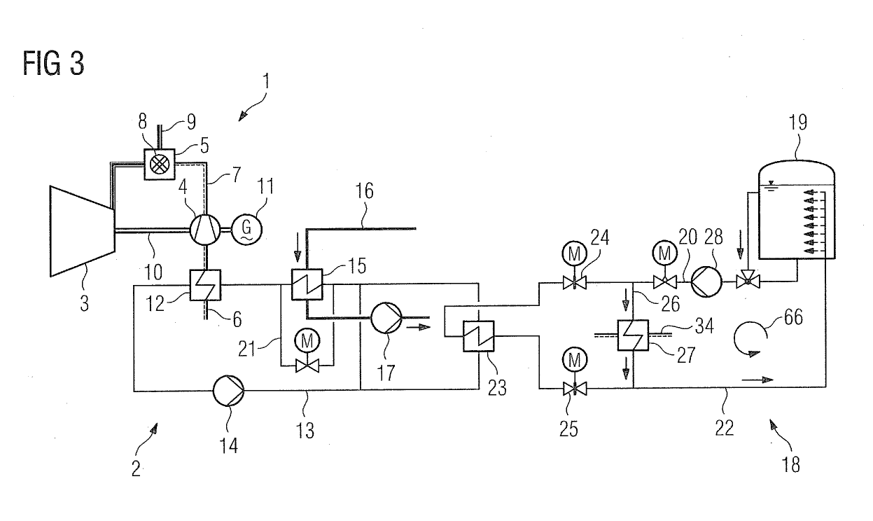

FIG. 3 shows an intake air temperature control device 18 according to a second embodiment variant of the invention with indirect cooling of the fluid circulating in the intake air preheating system 2. In this case a heat exchanger 23 is connected at one side into the circuit 13 of the intake air preheating system 2 and at the other side between the first fluid line 20 and second fluid line 22.

In order to charge the reservoir 19 the valves 24, 25 in the first fluid line 20 and second fluid line 22, respectively, are closed. A third fluid line 26 connects the first fluid line 20 to the second fluid line 22 and leads via a heat exchanger 27 through which cold air flows on the secondary side. A pump 28 is provided to ensure that the fluid is continuously circulated and cooled down further in the circuit 66. The cooled fluid, at e.g. up to −40° C., is stored in the reservoir 19. Depending on its design this day tank can hold e.g. up to 1000 m³.

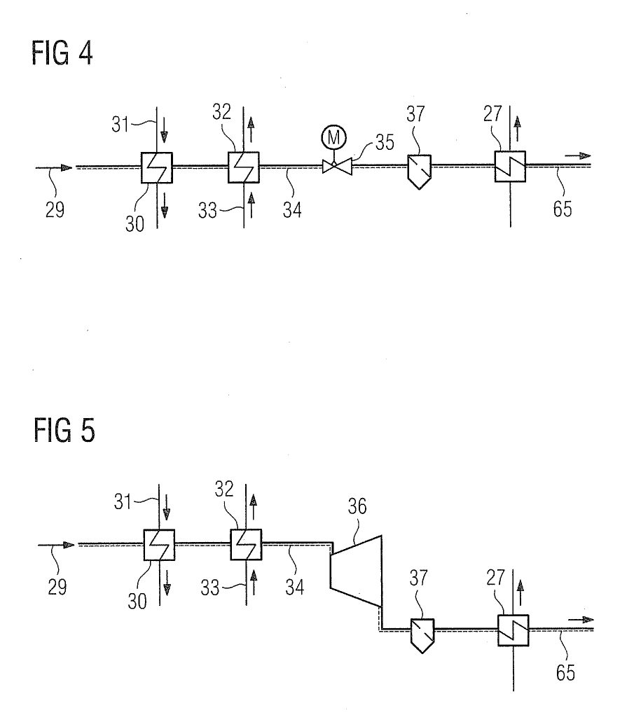

FIGS. 4 and 5 show how the cold air for cooling the fluid is generated. Hot compressed air 29 from the gas turbine compressor 4 is cooled down in the heat exchange with water from the water-steam circuit, while in the process steam production simultaneously increases in the heat recovery steam generator. For this purpose, as shown in FIGS. 4 and 5, a heat exchanger 30 for medium-pressure feedwater 31 and a heat exchanger 32 for condensate 33 are connected into the compressor air line 34.

A throttle 35, as shown in FIG. 4, or an expansion turbine 36, as shown in FIG. 5, expands the cooled air to ambient pressure, causing a further drop in the air temperature. Accumulating water and/or ice are separated off from the cooled air in a water-ice separator 37.

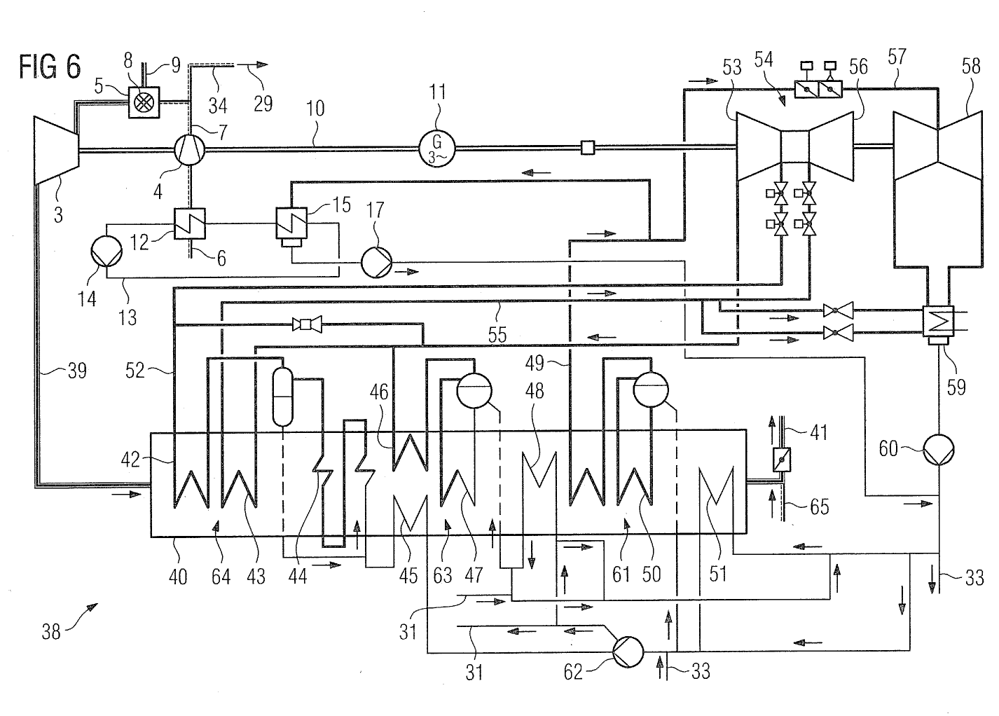

Said cold air cools the fluid by way of the heat exchanger 27 known from FIGS. 2 and 3 and is then supplied 65 to a flue 41 (see FIG. 6). Alternatively the cold air can also be used in a cooling circuit for cooling the generator or in the condenser.

In another solution the cold could also be generated by means of conventional chillers.

FIG. 6 shows a gas and steam turbine plant 38. Following on from the description with reference to FIG. 1, the hot exhaust gases of the gas turbine plant 1 are supplied by way of the exhaust gas line 39 to the heat recovery steam generator 40 and flow through the latter until they are discharged to the environment through a flue 41. On their way through the heat recovery steam generator 40 they supply their heat to a high-pressure superheater 42, then to a high-pressure reheater 43, a high-pressure evaporator 44, a high-pressure preheater 45, then to a medium-pressure superheater 46, a medium-pressure evaporator 47, a medium-pressure preheater 48, then to a low-pressure superheater 49, a low-pressure evaporator 50 and finally a condensate preheater 51.

Steam superheated in the high-pressure superheater 42 is supplied through a steam delivery line 52 to a high-pressure stage 53 of the steam turbine 54 and expanded there, performing work in the process. Analogously to the work performed in the gas turbine, the work causes the shaft 10 and consequently the generator 11 for generating electrical energy to move. The hot steam partially expanded in the high-pressure stage 53 is then supplied to the high-pressure reheater 43, where it is reheated and supplied by way of a delivery line 55 or steam feeder line to a medium-pressure stage 56 of the steam turbine 54 and expanded there, performing mechanical work in the process. The steam partially expanded there is supplied by way of a feeder line 57 together with the low-pressure steam from the low-pressure superheater 49 to a low-pressure stage 58 of the steam turbine 54, where it is further expanded, releasing mechanical energy in the process.

The expanded steam is condensed in the condenser 59 and the condensate thus resulting is supplied by way of a condensate pump 60 directly to a low-pressure stage 61 of the heat recovery steam generator 40 or by way of a feed pump 62 and, provided with corresponding pressure by the latter, is fed to a medium-pressure stage 63 or a high-pressure stage 64 of the heat recovery steam generator 40, where the condensate is evaporated. Following a steam discharge and superheating the steam is re-supplied by way of the corresponding delivery lines of the heat recovery steam generator 40 to the steam turbine 54 for expansion and performance of mechanical work.

As already described with reference to FIGS. 4 and 5, in order to integrate the cold generation into the water-steam circuit of the gas and steam turbine plant 38, hot compressed air 29 is branched off from the gas turbine compressor 4, cooled down in the heat exchange with medium-pressure feedwater 31 and condensate 33, and at the end of the fluid cooling process is ducted back 65 into the flue 41.

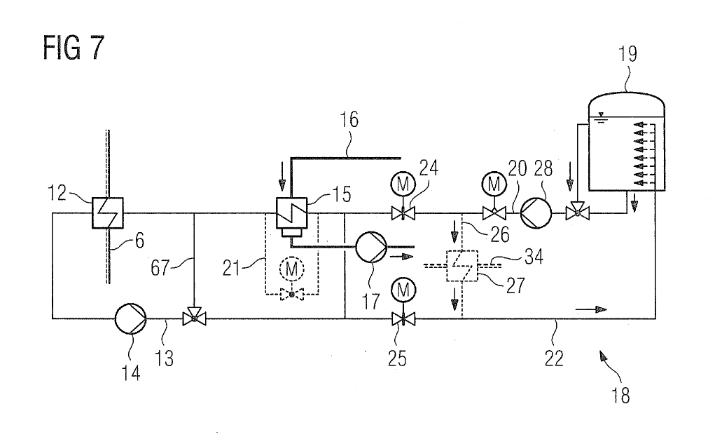

FIG. 7 shows the alternative use of the reservoir 19 as a heat accumulator. The fluid stored in the reservoir 19 is pumped by a pump 28 into the intake air preheating system 2. In this case the line 26 by way of the air-fluid heat exchanger 27 and the bypass line 21 are closed. The fluid is heated in the heat exchanger 15 by means of steam from the water-steam circuit 16 of the gas and steam turbine plant 38. The heated fluid is subsequently not routed by way of the heat exchanger 12, but is returned directly to the reservoir 19 by way of the line 67.

In order to draw off the heat, i.e. to heat up the intake air, the fluid is pumped out of the reservoir 19 into the intake air preheating system 2 and ducted through the intake air heat exchanger 12 shown in FIGS. 1 to 3.

1-15. (canceled)

16. An intake air temperature control device for a gas and steam turbine plant, comprising:
a first heat exchanger which is connected at one side into an intake air line and at the other side into a circuit of an intake air preheating system; and
a reservoir for a cooled heat transfer fluid which may be thermally coupled to the circuit in order to cool intake air,
wherein in order to utilize a capacity of the gas and steam turbine plant, a portion of the generated energy may be converted into cooled fluid and stored.

17. The intake air temperature control device as claimed in claim 16,
wherein the reservoir is thermally coupled to the circuit by means of a first fluid line that branches off from the reservoir and leads into the circuit and a second fluid line that branches off from the circuit and leads into the reservoir.

18. The intake air temperature control device as claimed in claim 16,
wherein a second heat exchanger is inserted into the circuit and connected to the reservoir by way of a first and a second fluid line.

19. The intake air temperature control device as claimed claim 16,
further comprising a reservoir circuit which includes the reservoir, a third fluid line connected between the first and the second fluid line, and sections of the first and the second fluid line from the reservoir up to the third fluid line,
wherein an air-fluid heat exchanger is connected at one side into the reservoir circuit and at the other side into an air line branching off from a compressor.

20. The intake air temperature control device as claimed in claim 19, wherein a further heat exchanger is connected into the air line in a flow direction of the air on a primary side upstream of the air-fluid heat exchanger for the purpose of cooling the air.

21. The intake air temperature control device as claimed in claim 20, wherein a pressure reducing valve is connected into the air line between the further heat exchanger and the air-fluid heat exchanger.

22. The intake air temperature control device as claimed in claim 20, wherein an air expansion turbine is connected into the air line between the further heat exchanger and the air-fluid heat exchanger.

23. The intake air temperature control device as claimed in claim 16, wherein the heat transfer fluid comprises water and an antifreezing agent.

24. A gas and steam turbine plant, comprising:
an intake air temperature control device as claimed in claim 16.

25. The turbine plant as claimed in claim 24,
wherein the reservoir is thermally coupled to the circuit by means of a first fluid line that branches off from the reservoir and leads into the circuit and a second fluid line that branches off from the circuit and leads into the reservoir.

26. The turbine plant as claimed in claim 24,
wherein a second heat exchanger is inserted into the circuit and connected to the reservoir by way of a first and a second fluid line.

27. The turbine plant as claimed claim 24,
further comprising a reservoir circuit which includes the reservoir, a third fluid line connected between the first and the second fluid line, and sections of the first and the second fluid line from the reservoir up to the third fluid line,
wherein an air-fluid heat exchanger is connected at one side into the reservoir circuit and at the other side into an air line branching off from a compressor.

28. The turbine plant as claimed in claim 27, wherein a further heat exchanger is connected into the air line in a flow direction of the air on a primary side upstream of the air-fluid heat exchanger for the purpose of cooling the air.

29. The turbine plant as claimed in claim 28, wherein a pressure reducing valve is connected into the air line between the further heat exchanger and the air-fluid heat exchanger.

30. A method for operating an intake air temperature control device for a gas and steam turbine plant having an intake air preheating system, comprising:
cooling a fluid by means of a portion of a generated energy and stored in a reservoir in order to utilize a capacity of the gas and steam turbine plant;
drawing off the fluid from the reservoir for the purpose of transferring heat; and
supplying the fluid to the intake air preheating system for the purpose of cooling intake air.

31. The method as claimed in claim 30, wherein compressed compressor air is cooled in the heat exchange with water.

32. The method as claimed in claim 31, wherein a throttle expands the cooled compressor air.

33. The method as claimed in claim 31, wherein an expansion turbine expands the compressor air.

34. The method as claimed in claim 32, wherein expanded compressor air cools the fluid in the heat exchange.

35. The method as claimed in claim 33, wherein expanded compressor air cools the fluid in the heat exchange.
